(19) United States
(12) Patent Application Publication
(10) Pub. No.: US 2007/0153062 A1
(43) Pub. Date: Jul. 5, 2007

(54) Monolithic fabrication method and structure of array nozzles on thermal inkjet print head

(76) Inventors: Jin Shown Shie, Hsinchu (TW); Thunter Hwang, Yongkang City (TW); Chin-Wen Huang, Hsinchu city (TW); Chien Chung Lin, Jhudong Township (TW)

Correspondence Address: PERKINS COIE LLP, P.O. BOX 2168, MENLO PARK, CA, 94026, US

(21) Appl. No.: 11/322,875

(22) Filed: Dec. 30, 2005

(51) Int. Cl. B41J 2/04

(52) U.S. Cl. 347/56; 347/54

(57) ABSTRACT

A fabrication method and structure of array nozzles on thermal inkjet print head is provided. Volcano shape array nozzles and inkjet vaporization chambers with accurate alignment to the individual positions of micro-heating elements on the wafer surface are obtained by using lithography and copper plating methods. The nozzles are made of (photolithographic) polymer materials, such as polyimide, being susceptible to operate in elevated temperature. The size and location of all nozzles can be defined accurately and simultaneously by a masked lithographic process, so that excellent dimension control over all nozzles can be achieved for quality inkjet printing. The extended shape to the outer surface of the nozzle plate can be engraved by another masked process into a tilting angle, in order to meet requirement of fluid dynamic for better ink jetting.

### BACKGROUND OF THE INVENTION

1. Field of the Invention

The invention relates to a fabrication method and structure of array nozzles on a thermal inkjet print-head. In particular, the invention relates to a fabrication method of making volcano shaped array nozzles and inkjet vaporization chambers by using lithography and plating methods.

2. Description of the Related Art

An inkjet printer with its low cost and high quality of color printing is used widely in personal computing. The most important part of an inkjet printer is the array nozzles on its thermal inkjet print-head. FIG. 1 illustrates the fabrication process steps of a nozzle in cross sectional views of the prior art. In FIG. 1A, MOS and metallization is made by conventional CMOS process in a silicon wafer 102. The process is described as below: A silicon dioxide layer 104 is thermally grown to be the field oxide. A BPSG layer 106 is deposited to be the inter-metal dielectric (IMD). A resistive metal, such as TaAl, to be used as thermal heating element 108 of the ink, is formed under the nozzle. A layer of aluminum electrode 110 is formed for supply control power to the heating element 108. Then, a layer of Si₃N₄/SiC 112, a passivation layer 114 and a tantalum pattern 111 are formed to protect the heating element 108 and transfer the heat to the ink. Referring to FIG. 1B, a photo-sensitive polyimide layer 118 is formed on the wafer, then by lithography process, a channel is formed for micro-channel ink slot 122 above the heating element 108 for supplying ink. On the back side of the wafer, an ink slot 124 is drilled through the wafer by a micro-machining method. Referring to FIG. 1C, an orifice (nozzle) plate 125 is formed on the top of the heat element 108 and the ink slot 122 by adhesion. This process is very difficult as the alignment needs a precision mechanical aligner which is very expensive and difficult to operate, however, the yield is still low. Also, the carbide adhesion layer 116 needs a high temperature to make the orifice (nozzle) plate 125 adhesive to the polyimide ink barrier layer 118. This may affect the function of the MOS circuits. FIG. 1D shows the operation of ink firing after an ink cartridge 120 is connected to the nozzle. As power is supplied to the heating element 108 from the aluminum electrode 110, the heat will heat up the ink above the heating element 108 and a bubble 130 is formed to cause an ink jet 132 coming out to form a dot on a paper.

There is a need for fabricating array nozzles and inkjet vaporization chambers with accurate alignment and without thermal adhesion to improve the yield of production.

### SUMMARY OF THE INVENTION

It is therefore an object of the invention to provide an array of volcano shaped nozzles and inkjet vaporization chambers by using lithography and plating methods to meet the requirement of fluid dynamic for better ink jetting.

Another object of the invention to provide a manufacturing method using masked lithography process to make the nozzle size and location of all orifices defined accurately and simultaneously so that excellent dimension control over all nozzles can be achieved for quality inkjet printing.

It is yet another object of the invention to provide a manufacturing method monolithically without mechanical aligner and high temperature adhesion.

In order to achieve the above objects, a first aspect of the present invention teaches a structure of array micro-nozzles and ink vaporization chambers formed by lithography and plating process on silicon wafer. The structure includes a processed silicon wafer that contains MOS integrated circuits for performing inkjet printing functions, including a heating element, aluminum electrodes and passivation layer. The structure further includes an array of nozzles. The array of nozzles have a volcano shape with an extended tilting angle to the outer surface of the nozzle plate for meeting the requirement of fluid dynamic to give better ink jetting. The nozzles are formed on the processed silicon wafer. The structure additionally includes an array of vaporization chambers that are formed on one side of the array of nozzles to be ink supply channels and vaporization chambers. An array of ink slot drillings is included and formed on the back side of the silicon wafer under the vaporization chambers for supplying ink from an ink cartridge.

A second aspect of the present invention teaches a fabrication method of inkjet print-head chips having an array of volcano shaped nozzles and ink vaporization chambers. The method includes the following steps: Step. 1, depositing a thin layer of electrically conductive metal film on a semi-finished wafer containing inkjet print-head ICs to be the plating electrode of copper plating; Step. 2, a thick layer of photo-resist polymer material is spun on the semi-finished wafer with thickness comparable to the requirement for micro fluid channels of ink; Step. 3, a mask process is adopted for patterning the photo-resist polymer for the final micro ink fluid channels; Step. 4, a layer of copper is electroplated on the wafer surface complementary to the polymer pattern with thickness comparable to the polymer material; Step. 5, strip away the polymer material and etch out the electrically conductive metal film; Step. 6, a cover layer of polyimide is spun on the surface; Step. 7, a second mask process is taken for patterning the cover polyimide to define the nozzle location, Step. 8, a thin layer of electrically conductive metal film is deposited on the top of the cover layer of polyimide to be the plating electrode of copper plating; Step. 9, a thick layer of photo-resist material is spun on and a mask process is adopted to form the opening of the nozzle; Step. 10, copper is electroplated on the top to a thickness comparable to that of the nozzle plate; Step. 11, an etching stop cap layer on top is formed; Step. 12, a third mask process is used to define the size of the nozzle openings, leaving the rest surface of copper exposed to the air; Step. 13, the copper and the electrically conductive metal film without the cap layer protection are etched out, the effect of lateral etching causing the un-attacked copper substance to form into volcano shape; Step. 14, release the cap layer, the photo-resist and electrically conductive metal film, exposing the array micro-volcanoes; Step. 15, spin on polyimide cover layer on top of the copper layer; Step. 16, a fourth mask process of nozzle openings on polyimide is performed to expose the copper layer with an extended shape to the outer surface of the nozzle plate with a tilt angle; Step. 17, etch copper layer, strip out electrically conductive metal film; a volcano shape nozzles and an inkjet vaporization chamber are formed; wafer clean and bake; Step. 18, an ink slot is drilled through the wafer on the back side by micro-machining technology.

### BRIEF DESCRIPTION OF THE DRAWINGS

FIG. 1 illustrates prior art fabrication process steps of a nozzle in cross sectional views.

FIG. 2 illustrates the manufacturing process steps of making array nozzles on a silicon wafer in accordance with the present invention.

FIG. 3 illustrates the operation of ink firing after an ink cartridge is connected to the nozzle in accordance with the present invention.

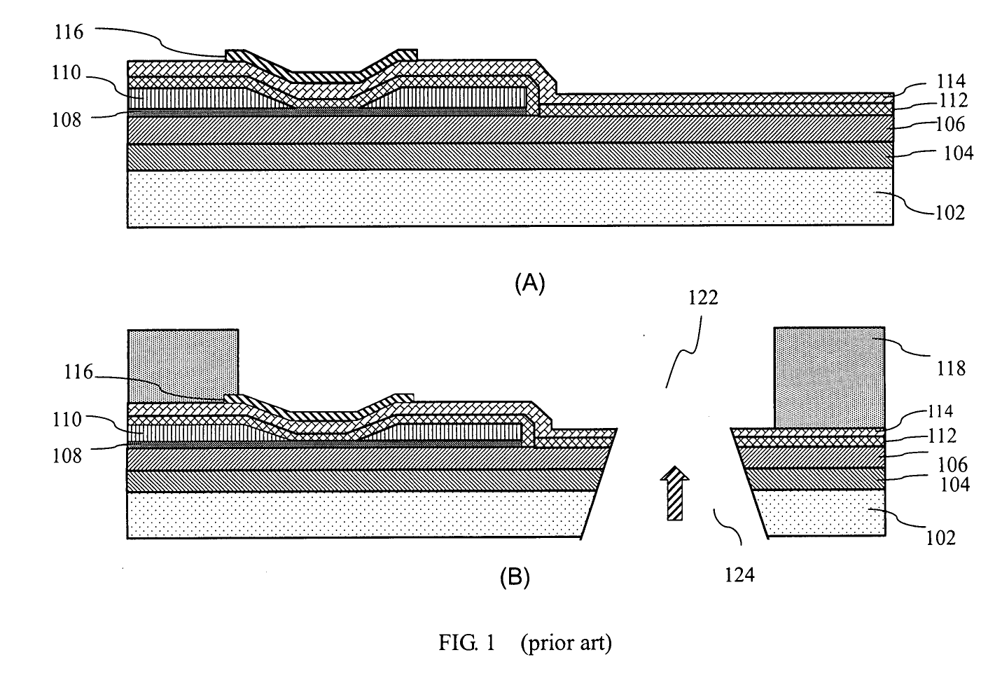

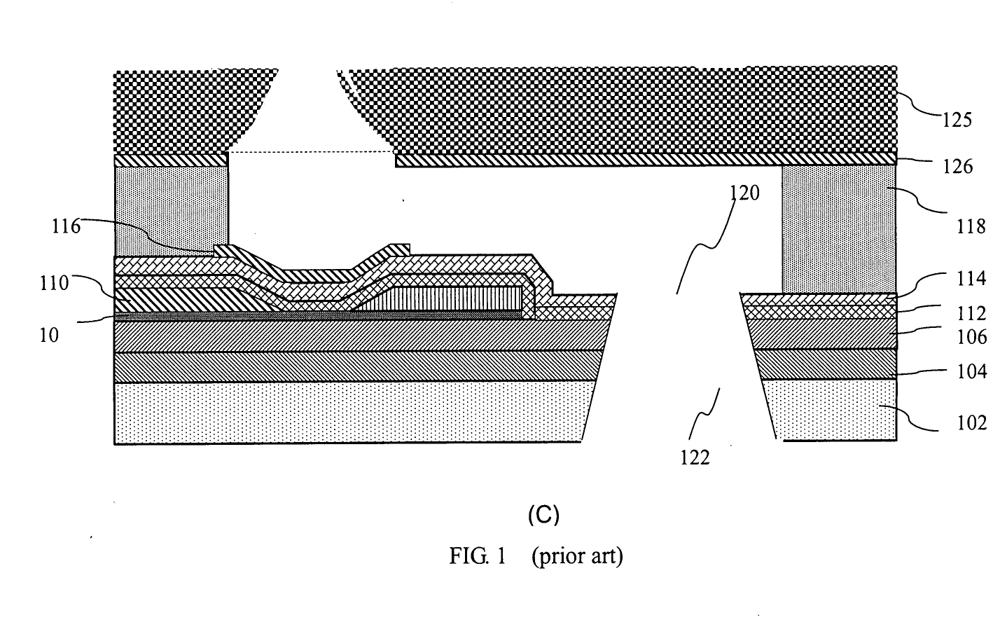

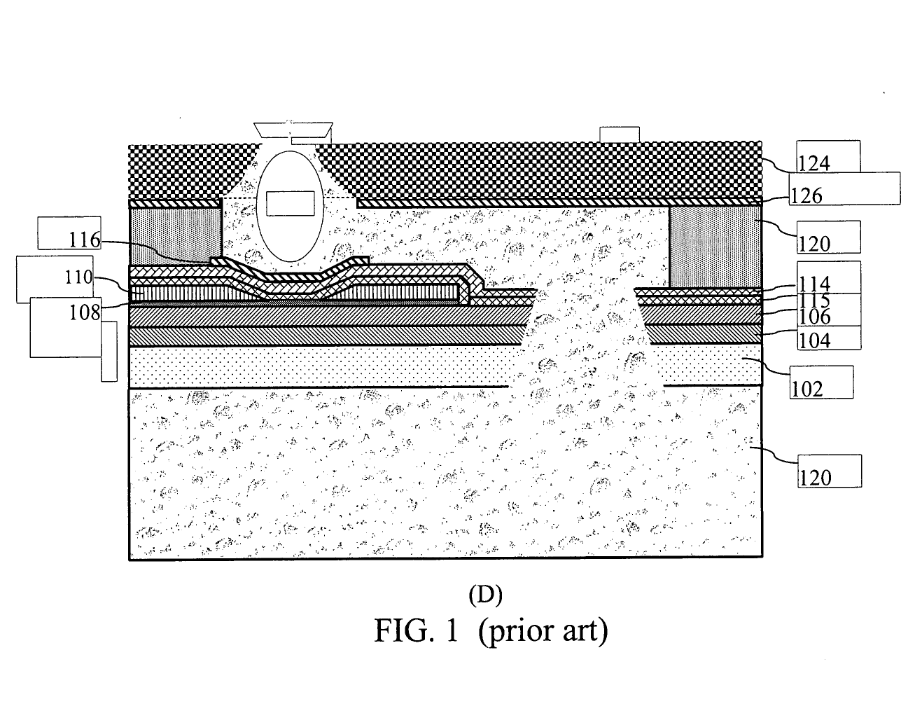

### DETAILED DESCRIPTION OF THE INVENTION

The present invention is a monolithic fabrication method and structure for providing volcano shaped nozzles on thermal inkjet and ink vaporization chamber with accurate alignment to the individual positions of micro-heating elements on the wafer surface.

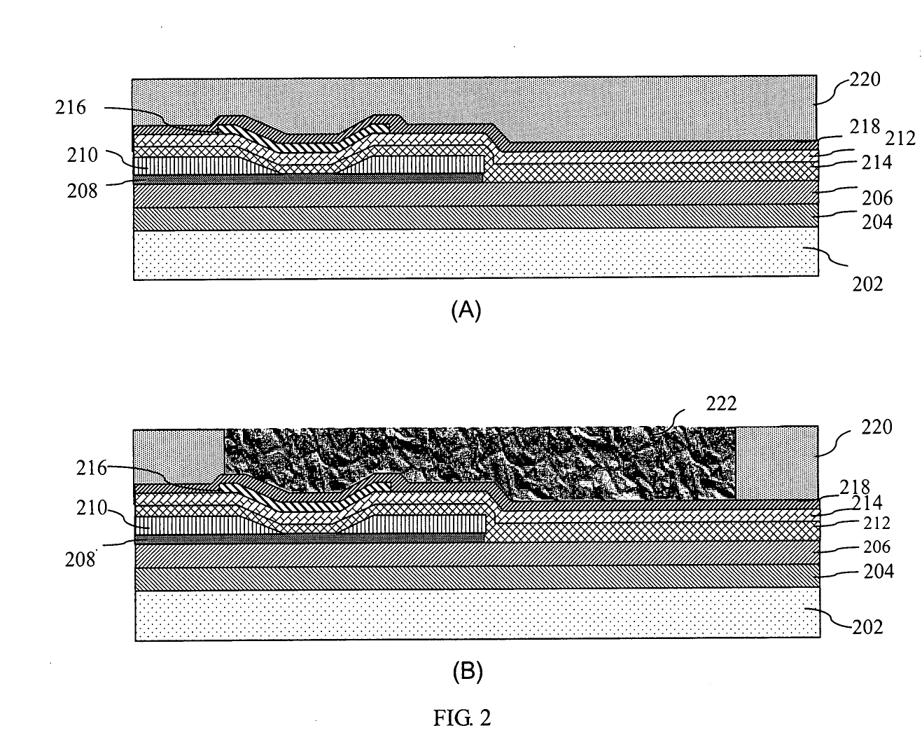

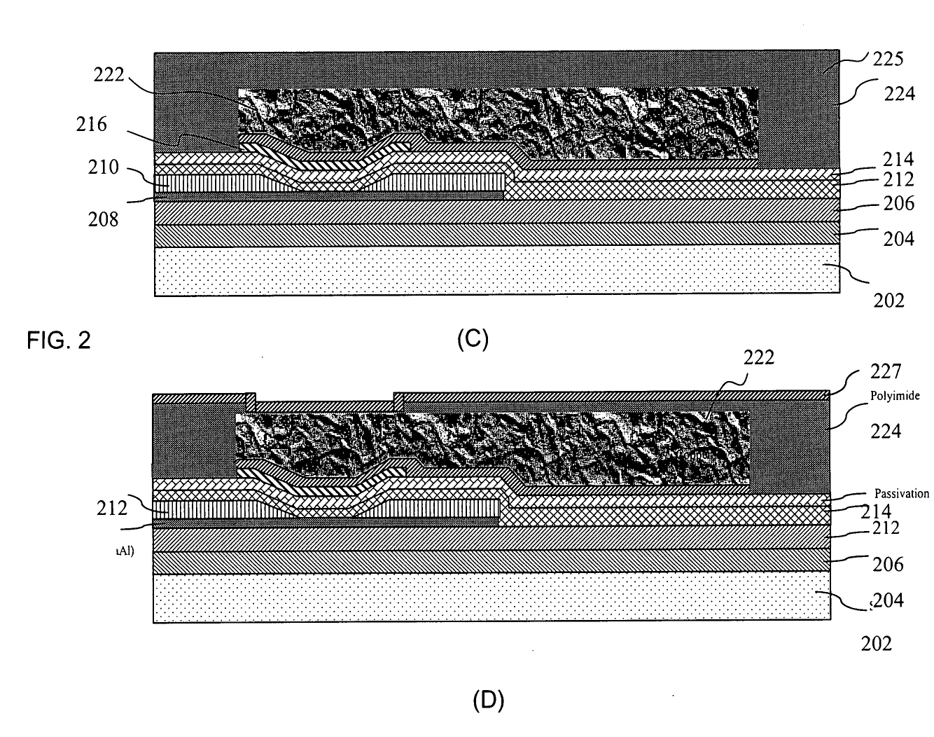

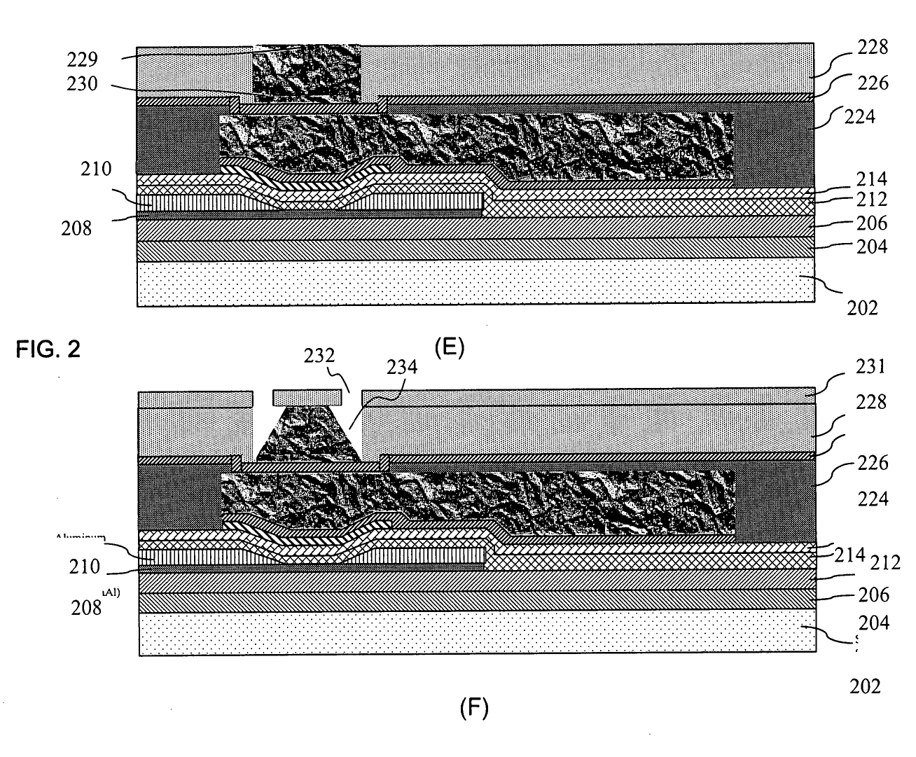

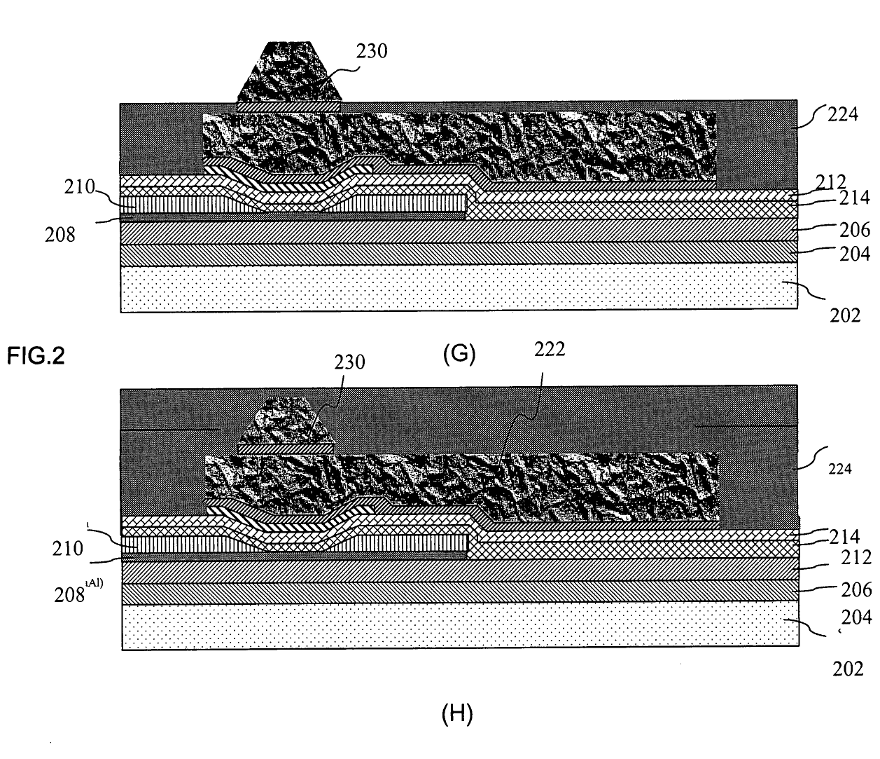

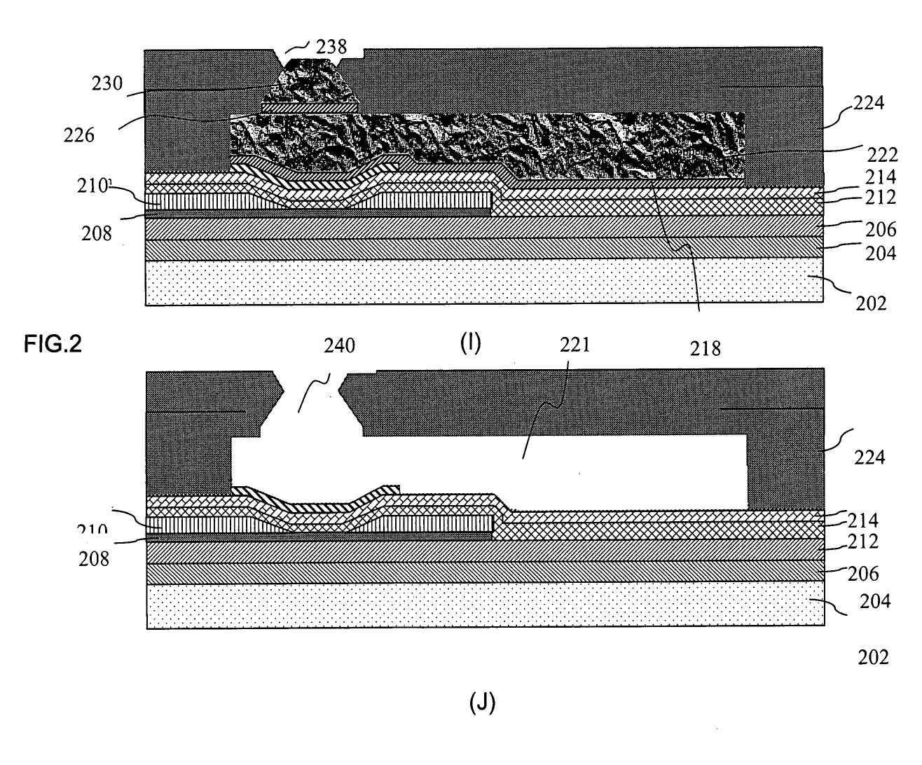

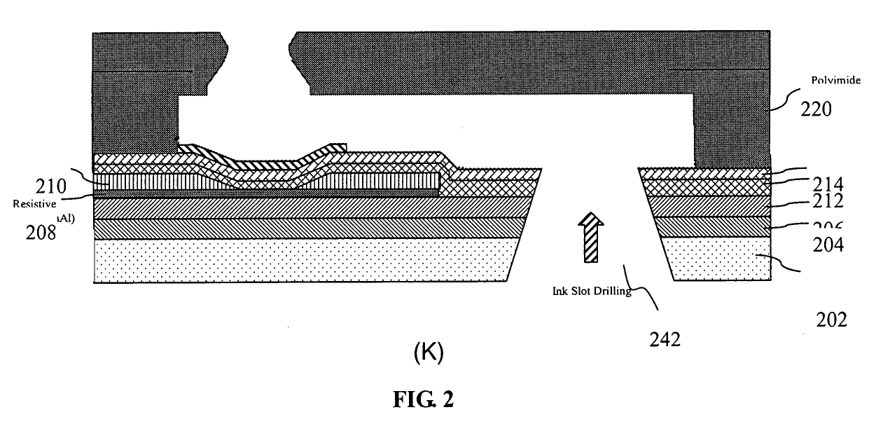

FIG. 2 illustrates the manufacturing process steps of making array nozzles on a silicon wafer in accordance with the present invention. In FIG. 2A, a semi-finished wafer containing inkjet print-head ICs is made by conventional CMOS process in a silicon wafer 202. The MOS and metallization process is described as below: A silicon dioxide layer 204 is thermally grown to be the field oxide. A BPSG layer 206 is deposited to be the inter-metal dielectric (IMD). A resistive metal, such as TaAl, to be used as thermal heating element 208 of the ink, is formed under the nozzle. A layer of aluminum electrode 210 is formed for supply control power to the heating element 208. Then, a layer of Si₃N₄/SiC 212, a passivation layer 214 and a tantalum pattern 211 are formed to protect the heating element 208 and transfer the heat to the ink. After the process of semi-finished wafer containing inkjet print-head ICs has completed, a thin layer of chrome copper (CrCu) 218 of 100 mm to 1000 nm, or other suitable electrically conductive metal film, is deposited on the semi-finished wafer containing inkjet print-head ICs to be the plating electrode of copper plating. A thick layer of photo-resist polymer material 220 is then spun on the semi-finished wafer. The thickness of the polymer material layer 220 is comparable to the requirement for micro fluid channels of ink. Referring to FIG. 2B, a mask process is adopted for patterning the photo-resist polymer. The residual material is left to occupy the space to be used for the final micro ink fluid channels. A layer of copper 222 is electroplated on the wafer surface complementary to the polymer pattern with the thickness comparable to the polymer material 220. The polymer material 220 is then stripped away and the CrCu under layer 218 is etched out. Referring to FIG. 2C, a cover layer of polyimide 225 is spun on the surface. Referring to FIG. 2D, a second mask process is taken for patterning the cover polyimide 225 to define the nozzle location 226. Subsequently, a thin layer of CrCu film 227 is deposited on the top of the cover layer of polyimide 225 to be the plating electrode of copper plating. Referring to FIG. 2E, a thick layer of photo-resist material 228 is spun on and a mask process is adopted to form the opening of the nozzle 229. Then, copper 230 is electroplated on the top to a thickness comparable to that of a nozzle plate, referring to FIG. 2F. An etching stop cap layer 231 on top is subsequently placed. This layer can be anything capable of resisting the copper etching solution. Next, another mask etching process is used to define the size of the nozzle openings 232, or the orifices, thus leaving the rest surface of copper exposed to the air. The copper 230 and the CrCu under layer 226 without the cap layer protection are subsequently etched out. Because of the effect of lateral etching, the un-attacked copper substance is formed into volcano shape due to the etching process. The characteristic shape is determined by the etch recipe chosen. Referring to FIG. 2G, the cap layer 231, the photo-resist 228 and Cr/Cu layer 226 are released and the array micro-volcanoes are exposed. Referring to FIG. 2H, the polyimide cover layer 236 is spun on top of the copper layer 222 and 230. Referring to FIG. 2I, a mask step of nozzle openings on polyimide is performed to expose the copper layer 230 with an extended shape to the outer surface of the nozzle plate with a tilt angle 238. Then, copper layer 230 is etched, CrCu is stripped out under layer 218, the copper layer 222 is further etched, and CrCu is further stripped under layer 228. Now coming to FIG. 2J, volcano shaped nozzles 240 and an inkjet vaporization chamber 221 is formed. After a thorough wafer clean and bake, the complete architecture of the present invention of monolithic processed thermal inkjet print-head IC is completed. Refer to FIG. 2K, on the back side, an ink slot 242 is drilled through the wafer by conventional micro-machining technology. The manufacturing process is then completed.

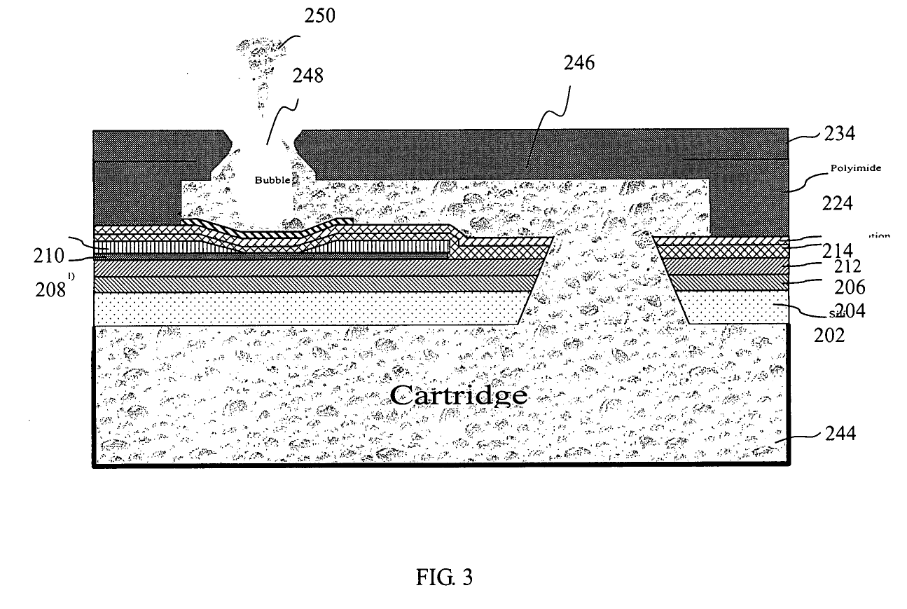

FIG. 3 shows the operation of ink firing after an ink cartridge 244 is connected to the nozzle. As power is supplied to the heating element 208 from the aluminum electrode 210, the heat will heat up the ink 246 above the heating element 208 and a bubble 248 is formed to cause an ink jet 250 coming out to form a dot on a paper.

Although the present invention has been explained in relation to its preferred embodiment, it is to be understood that many other possible modifications and variations can be made without departing from the spirit and scope of the invention as hereinafter claimed.

What is claimed is:

1. A structure of array micro-nozzles and ink vaporization chambers formed by lithography and plating process on silicon wafer, comprising:
a processed silicon wafer containing MOS integrated circuits performing inkjet printing function, including a heating element, aluminum electrodes and a passivation layer;
an array of nozzles, having volcano shape with an extended tilting angle to the outer surface of the nozzle plate for meeting the requirement of fluid dynamic to give better ink jetting, formed on said processed silicon wafer;
an array of vaporization chambers formed on one side of said array of nozzles capable of being ink supply channels and vaporization chambers;
an array of ink slot drillings formed on the back side of said silicon wafer under said vaporization chambers for supplying ink from an ink cartridge.

2. The structure as claimed in claim 1, wherein said array of nozzles are made of polyimide.

3. A fabrication method of inkjet print-head chips having an array of volcano shape nozzles and ink vaporization chambers, comprising the following steps:
depositing a thin layer of electrically conductive metal film on a semi-finished wafer containing inkjet print-head ICs to be the plating electrode of copper plating;
spinning a thick layer of photo-resist polymer material on the semi-finished wafer with thickness comparable to the requirement for micro fluid channels of ink;
adopting a mask process for patterning the photo-resist polymer for the final micro ink fluid channels;
electroplating a layer of copper on the wafer surface complementary to the polymer pattern with thickness comparable to the polymer material;
striping away the polymer material;
etching out the electrically conductive metal film;
spinning a cover layer of polyimide on the surface;
taking a second mask process for patterning the cover polyimide to define the nozzle location,
depositing a thin layer of electrically conductive metal film on the top of the cover layer of polyimide to be the plating electrode of copper plating;
spinning on a thick layer of photo-resist material;
adopting a mask process to form the opening of the nozzle;
electroplating copper on the top to a thickness comparable to that of the nozzle plate;
forming an etching stop cap layer on top;
using a third mask process to define the size of the nozzle openings, leaving the rest surface of copper exposed to the air;
etching out the copper and the electrically conductive metal film without the cap layer protection, wherein the effect of lateral etching causes the un-attacked copper substance to form into volcano shape;
releasing the cap layer, the photo-resist and electrically conductive metal film;
exposing the array micro-volcanoes;
spinning on polyimide cover layer on top of the copper layer;
performing a fourth mask process of nozzle openings on polyimide to expose the copper layer with an extended shape to the outer surface of the nozzle plate with a tilt angle;
etching the copper layer;
striping out electrically conductive metal film;
forming volcano shape nozzles and an inkjet vaporization chamber;
cleaning and baking the wafer;
drilling an ink slot through the wafer on the back side by micro-machining technology.

4. The fabrication method as claimed in claim 3, wherein said electrically conductive metal is chrome copper (CrCu).

5. The fabrication method as claimed in claim 3, wherein the thickness of said electrically conductive metal is 100 nm to 1000 nm.

6. The fabrication method as claimed in claim 3, wherein said photo-resist polymer material is polyimide.

7. The fabrication method as claimed in claim 3, wherein the thickness of said photo-resist polymer material layer is the same as the micro fluid channels of ink.

8. The fabrication method as claimed in claim 3, wherein said etching stop cap layer is a resisting material for the copper etching solution.
